(19) United States
(12) Patent Application Publication
(10) Pub. No.: US 2017/0349818 A1
(43) Pub. Date: Dec. 7, 2017

(54) METHODS OF ACTIVATING ENZYME BREAKERS

(71) Applicant: SCHLUMBERGER TECHNOLOGY CORPORATION, Sugar Land, TX (US)

(72) Inventors: Andrey Mirakyan, Katy, TX (US); Camille Meza, Sugar Land, TX (US); Richard Donald Hutchins, Sugar Land, TX (US)

(21) Appl. No.: 15/174,049

(22) Filed: Jun. 6, 2016

(51) Int. Cl. C09K 8/70; C09K 8/88; C09K 8/68; E21B 43/267; E21B 43/26

(52) U.S. Cl. CPC C09K 8/706; E21B 43/267; E21B 43/26; C09K 8/685; C09K 8/887; C09K 2208/24

(57) ABSTRACT

A well treatment fluid is disclosed containing water, a crosslinkable component, a crosslinker; and an enzyme breaker containing a cellulase enzyme, the well treatment fluid having a total dissolved solids content of at least about 75,000 mg/L up to about 250,000 mg/L. A method of treating a subterranean formation is also disclosed including placing the well treatment fluid in the subterranean formation. It is also disclosed that the well treatment fluid can be a combination of a first fluid including water, the crosslinkable component, the crosslinker, and the enzyme breaker, and having a total dissolved content A with formation water having a total dissolved content B which is higher than the total dissolved content A of the first fluid.

### FIELD

The disclosure generally relates to methods for treating a subterranean formation, and more particularly, but not by way of limitation, treating a subterranean formation with a well treatment fluid having an elevated total dissolved solids content and including at least a crosslinkable component, a crosslinker, and an enzyme breaker.

### BACKGROUND

Hydrocarbons (oil, natural gas, etc.) may be obtained from a subterranean geologic formation (a “reservoir”) by drilling a well that penetrates the hydrocarbon-bearing formation. Well treatment methods often are used to increase hydrocarbon production by using a treatment fluid to interact with a subterranean formation in a manner that ultimately increases oil or gas flow from the formation to the wellbore for removal to the surface.

Well treatment fluids, particularly those used in fracturing (fracturing fluids) or those used in gravel packing operations (gravel packing fluids), may comprise a water or oil based fluid incorporating a thickening agent, normally a polymeric material. Such polymeric thickening agents can also include crosslinkable components. Polymeric thickening agents for use in such fluids may comprise galactomannan gums, such as guar and substituted guars such as hydroxypropyl guar and carboxymethylhydroxypropyl guar (CMHPG). Cellulosic polymers such as carboxymethyl cellulose (CMC) may also be used, as well as synthetic polymers such as polyacrylamide. Such fracturing fluids can have a high viscosity during a treatment to develop a desired fracture geometry and/or to carry proppant into a fracture with sufficient resistance to settling. These fluids can also develop a filter cake which includes the polymeric additives.

The recovery of the fracturing fluid is achieved by reducing the viscosity of the fluid such that the fluid flows naturally through the proppant pack. Chemical reagents, such as oxidizers, chelants, acids and enzymes may be employed to break the polymer networks to reduce their viscosity. These materials are commonly referred to as “breakers” or “breaking agents.” Such conventional fracturing fluid breaking technologies are known and work well at relatively low and high temperatures.

Most polymeric fluids used in oilfield applications damage the formation by leaving behind a filtercake used to control fluid leak-off into the formation and to restrict the inflow of reservoir fluids into the formation rock during drilling and completion techniques. If the filtercake damage is not removed prior to or during completion of the well, a range of issues can arise, for example, completion equipment failures, impaired reservoir productivity, and so on.

The major components typically found in filtercakes can include polymers, such as starch, guar, derivatized guars such as CMHPG, cellulosic polymers such as CMC, xanthan gum, polyacrylamides and co- or ter-polymers containing acrylamide, acrylic acid, vinyl pyrrolidone or acrylamido-methyl-propane sulfonate monomers and solids, such as carbonates, silica, mica and other inorganic salts and clays. The solids in the mud or fluid are sized such that they can form an efficient bridge across the pores of the formation rock as the well is being drilled or during injection of the fluid during the fracturing process. As the solids in the mud or fluid develop bridges across the exposed pores or pore throats of the reservoir, the polymeric fluid loss material from the mud or fluid can be co-deposited within the interstices of the solid bridging particles, thus sealing off the reservoir from the wellbore or fracture. These polymeric materials can comprise an integral component of the resulting filtercake, typically 17 to 20 weight percent of the dry filtercake, and can be responsible for the ultra-low permeability of the filtercake. Often, aqueous-based fracturing fluids are used without added solids and the filter cake that develops is due to the inability of the polymeric component to enter the formation rock. The water component of the fracturing fluid leaks off into the matrix while leaving behind concentrated polymer that can form a filter cake which inhibits further fluid loss.

As compared to oxidative breakers, benefits potentially associated with enzymes include high selectivity towards the polymer backbone, breaking with just small amounts of the enzyme breaker, can be effective, and a better health, safety and environmental (HSE) profile. Enzymes can be higher in molecular weight than oxidative breakers so that they tend not to leak off into the surrounding formation, and can also be less susceptible to dramatic changes in activity by trace contaminants. Enzymes can be used to degrade polymers and can facilitate uniform treatment of the filter cake induced damage.

However, enzymes used in conventional filter cake removal are subject to some limitations, such as the loss of suitable enzymatic activity at downhole conditions and possible permanent denaturation of the enzyme, rendering its activity to be essentially zero, before a sufficient period of time has elapsed that is adequate for the enzyme to break the polymer. For oilfield applications, enzyme reaction times are usually at least 4 hours at temperature for mud cake removal and even longer for fracture cleanup. Activity of the enzyme, or the ability of the enzyme to catalyze breaking of the polymer by hydrolysis, for example, may also be an important benefit. However, because the enzyme is a catalyst rather than a reactant which would otherwise be consumed in the breaking reaction, a small amount of active enzyme may be effective where the enzyme concentration is not rate-limiting.

Other limitations of enzymes include these materials being extremely sensitive to pH, ionic strength and temperature. High salinity or high total dissolved solids content, especially in the presence of divalent ions like calcium, can also prematurely inactivate and/or coagulate enzymes.

Enzymes begin to lose their activity at higher temperatures. A major limitation of enzymes is their inability to stay active at temperatures above 93° C. (200° F.). For example, experimental studies reported in the literature show that the activity of enzymes at 97° C. (207° F.) is less than 10% of activity at 93° C. (200° F.). There can be variations in their activity at the upper temperature limit depending on the source of the enzyme, as one hemi-cellulase still retains some activity at 135° C. (275° F.).

For an improved enzyme breaker, oilfield applications generally seek applicability across a broader salinity range, e.g. above 75,000 mg/L; and a broader temperature range, e.g. above 93° C. (200° F.), above 107° C. (225° F.), or even above 121° C. (250° F.); storability without refrigeration, e.g. at or above ambient temperature; improved logistics; and easy mixing.

### SUMMARY

This summary is provided to introduce a selection of concepts that are further described below in the detailed description. This summary is not intended to identify key or essential features of the claimed subject matter, nor is it intended to be used as an aid in limiting the scope of the claimed subject matter.

In one aspect of the disclosure, methods of treating a subterranean formation are provided which include:

a) providing a well treatment fluid including water, a crosslinkable component, a crosslinker and an enzyme breaker including a cellulase enzyme; wherein the treatment fluid attains a temperature T1 from about 125° F. to about 275° F., has an initial pH from about 4.5 to about 8, a total dissolved solids content of at least about 75,000 mg/L up to about 250,000 mg/L, and an initial viscosity greater than about 150 cP measured at the temperature T1 and at a shear rate of 100 s⁻¹;
b) placing the well treatment fluid into the subterranean formation; and
c) wherein the viscosity of the well treatment fluid after about 1 or about 1.5 or about 2 or about 4 or about 6 or about 8 or about 12 or about 24 hours from placement in the subterranean formation is below about 100 cP measured at the temperature of use and at a shear rate of 100 s⁻¹.

In one aspect of the disclosure, methods of treating a subterranean formation are provided which include:

a) providing a well treatment fluid including water, a crosslinkable component including guar, a crosslinker including zirconium and an enzyme breaker including a cellulase enzyme selected from the group consisting of pyrolase enzyme, pyrolase HT enzyme, fraczyme enzyme, and combinations thereof; wherein the treatment fluid attains a temperature T1 from about 125° F. to about 275° F., has an initial pH from about 4.5 to about 8, a total dissolved solids content of at least about 75,000 mg/L up to about 250,000 mg/L, and an initial viscosity greater than about 150 cP measured at the temperature T1 and at a shear rate of 100 s⁻¹;
b) placing the well treatment fluid into the subterranean formation;
c) wherein the viscosity of the well treatment fluid after about 1.5 hours from placement in the subterranean formation is below about 100 cP measured at the temperature of use and at a shear rate of 100 s⁻¹.

### BRIEF DESCRIPTION OF DRAWINGS

The manner in which the objectives of the present disclosure and other desirable characteristics may be obtained is explained in the following description and attached drawings in which:

FIG. 1 is an illustration of the rheology profile of the fluids of Example 1.

FIG. 2 is an illustration of the rheology profile of the fluid of Example 2.

FIG. 3 is an illustration of the rheology profile of the fluids of Example 3.

FIG. 4 is an illustration of the rheology profile of the fluids of Example 4.

FIG. 5 is an illustration of the rheology profile of the fluids of Example 5.

FIG. 6 is an illustration of the rheology profile of the fluids of Example 6.

FIG. 7 is an illustration of the rheology profile of the fluids of Example 7.

FIG. 8 is an illustration of the rheology profile of the fluids of Example 8.

FIG. 9 is an illustration of the rheology profile of the fluids of Example 9.

FIG. 10 is an illustration of the rheology profile of the fluids of Example 10.

FIG. 11 is an illustration of the rheology profile of the fluids of Example 11.

FIG. 12 is an illustration of the rheology profile of the fluids of Example 12.

FIG. 13 is an illustration of the rheology profile of the fluids of Example 13.

FIG. 14 is an illustration of the rheology profile of the fluids of Example 14.

FIG. 15 is an illustration of the rheology profile of the fluids of Example 15.

FIG. 16 is an illustration of the rheology profile of the fluids of Example 16.

FIG. 17 is an illustration of the rheology profile of the fluids of Example 17.

### DETAILED DESCRIPTION

At the outset, it should be noted that in the development of any such actual embodiment, numerous implementation-specific decisions must be made to achieve the developer's specific goals, such as compliance with system related and business related constraints, which will vary from one implementation to another. Moreover, it will be appreciated that such a development effort might be complex and time consuming but would nevertheless be a routine undertaking for those of ordinary skill in the art having the benefit of this disclosure. In addition, the composition used/disclosed herein can also comprise some components other than those cited. In the summary of the invention and this detailed description, each numerical value should be read once as modified by the term “about” (unless already expressly so modified), and then read again as not so modified unless otherwise indicated in context. Also, in the summary of the invention and this detailed description, it should be understood that a concentration range listed or described as being useful, suitable, or the like, is intended that any and every concentration within the range, including the end points, is to be considered as having been stated. For example, “a range of from 1 to 10” is to be read as indicating each and every possible number along the continuum between about 1 and about 10. Thus, even if specific data points within the range, or even no data points within the range, are explicitly identified or refer to only a few specific, it is to be understood that inventors appreciate and understand that any and all data points within the range are to be considered to have been specified, and that inventors possessed knowledge of the entire range and all points within the range.

The statements made herein merely provide information related to the present disclosure and may not constitute prior art, and may describe some embodiments illustrating aspects of the invention.

Disclosed herein are well treatment fluid(s) and method(s) of treating a subterranean formation using such well treatment fluids.

The well treatment fluid(s) comprise, consist of, or consist essentially of water, a crosslinkable component, a crosslinker and an enzyme breaker comprising a cellulase enzyme; wherein the well treatment fluid has an initial pH from about 4.5 to about 8 or about 5 to about 7 or about 5 to about 6, a total dissolved solids content of at least about 75,000 mg/L up to about 250,000 mg/L or at least about 100,000 mg/L up to about 250,000 mg/L, and an initial viscosity greater than about 150 cP or greater than about 200 cP or greater than about 250 cP as measured at a temperature from about 125° F. to about 275° F. or about 150° F. to about 250° F. or about 170° F. to about 250° F. and at a shear rate of 100 s⁻¹.

The method can comprise, consist of, or consist essentially of:
a) providing the well treatment fluid, as described herein; wherein the well treatment fluid attains a temperature T1 from about 125° F. to about 275° F. or about 150° F. to about 250° F. or about 170° F. to about 250° F.;
b) placing the well treatment fluid into the subterranean formation; and
c) wherein the viscosity of the well treatment fluid after about 1 or about 1.5 or about 2 or about 4 or about 6 or about 8 or about 12 or about 24 hours from placement in the subterranean formation is below about 100 or about 80 or about 50 or about 20 or about 10 cP as measured at the temperature of use and at a shear rate of 100 s⁻¹. The term “temperature of use” as used herein refers to the temperature of the well treatment fluid after placement in the subterranean formation.

A method of treating a subterranean formation is also disclosed, the method comprising, consisting of, or consisting essentially of:
a) providing a first fluid comprising water, a crosslinkable component, a crosslinker, and an enzyme breaker comprising a cellulase enzyme, wherein the first fluid has a total dissolved content A;
b) placing the first fluid into the subterranean formation comprising an aqueous formation fluid having a total dissolved content B which is higher than the total dissolved content A of the first fluid;
c) combining the first fluid with the aqueous formation fluid in the subterranean formation to form the well treatment fluid as described herein, which has an initial pH from about 4.5 to about 8 or about 5 to about 7 or about 5 to about 6, a total dissolved solids content of at least about 75,000 mg/L up to about 250,000 mg/L or at least about 100,000 mg/L up to about 250,000 mg/L, wherein the well treatment fluid attains a temperature T1 from about 125° F. to about 275° F. or about 150° F. to about 250° F. or about 170° F. to about 250° F., and the viscosity of the well treatment fluid after attaining such temperature T1 is greater than about 150 cP or greater than about 200 cP or greater than about 250 cP as measured at a shear rate of 100 s⁻¹;
d) wherein the viscosity of the well treatment fluid after about 1 or about 1.5 or about 2 or about 4 or about 6 or about 8 or about 12 or about 24 hours from forming in the subterranean formation is below about 100 or about 80 or about 50 or about 20 or about 10 cP as measured at the temperature of use and at a shear rate of 100 s⁻¹.

A method of treating a subterranean formation is also disclosed, the method comprising, consisting of, or consisting essentially of:
a) providing a first fluid comprising water, a crosslinkable component, a crosslinker, and an enzyme breaker comprising a cellulase enzyme, wherein the first fluid has a total dissolved content A;
b) placing the first fluid into the subterranean formation comprising an aqueous formation fluid having a total dissolved content B which is lower than the total dissolved content A of the first fluid;
c) combining the first fluid with the aqueous formation fluid in the subterranean formation to form the well treatment fluid as described herein, which has an initial pH from about 4.5 to about 8 or about 5 to about 7 or about 5 to about 6, a total dissolved solids content of at least about 75,000 mg/L up to about 250,000 mg/L or at least about 100,000 mg/L up to about 250,000 mg/L, wherein the well treatment fluid attains a temperature T1 from about 125° F. to about 275° F. or about 150° F. to about 250° F. or about 170° F. to about 250° F., and the viscosity of the well treatment fluid after attaining such temperature T1 is greater than about 150 cP or greater than about 200 cP or greater than about 250 cP as measured at a shear rate of 100 s⁻¹;
d) wherein the viscosity of the well treatment fluid after about 2 hours from forming in the subterranean formation is below about 100 or about 80 or about 50 or about 20 or about 10 cP as measured at the temperature of use and at a shear rate of 100 s⁻¹.

The cellulase enzyme as described herein can be selected from the group consisting of pyrolase enzyme, pyrolase HT enzyme, encapsulated pyrolase HT enzyme, fraczyme enzyme (which is encapsulated), and combinations thereof. The crosslinkable component can be selected from the group consisting of guar, CMHPG, and combinations thereof. The crosslinker comprises a component selected from the group consisting of zirconium, titanium and aluminum. The cellulase enzyme can be present in the well treatment fluid in an amount of from about 0.0001 to about 0.03 wt % or from about 0.0005 to about 0.02 wt % or from about 0.0.001 to about 0.01 wt %, based on the total weight of the well treatment fluid. The crosslinkable component can be present in the well treatment fluid in an amount of from about 0.1 to about 0.72 wt % or from about 0.12 to about 0.5 wt % or from about 0.15 to about 0.36 wt %, based on the total weight of the well treatment fluid. The metal component of the crosslinker can be present in the well treatment fluid in an amount of from about 10 to about 200 ppm or from about 20 to about 100 ppm or from about 25 to about 75 ppm, based on the total weight of the well treatment fluid.

The enzyme breakers described herein can be inactivated enzymes that are capable of being activated or reactivated by a chemical or physical signal or by a change in fluid conditions. The enzymes can remain inactive until such time as a change in the properties of the fluid is desired. The enzyme is then activated upon exposure to a chemical or physical signal, or a change in the subterranean formation, such as a decrease or increase in pH and/or temperature. Upon activation, such enzymes are capable of selectively degrading fluid components, such as the crosslinkable component in the well treatment fluid.

As used in breaking technology, enzymes may be used to degrade the particular linkages found on the polymer backbone, such as the 1,4 beta-linkage between mannose in galactomannans in the case of mannanases or cellulosics, at particular temperature ranges where the enzyme is active. See, for example, U.S. Pat. Nos. 5,067,566; 5,201,370; 5,224,544; 5,226,479; 5,247,995; 5,421,412; 5,562,160; and 5,566,759, the disclosures of which are incorporated by reference herein in their entirety.

In accordance with an embodiment, the enzyme breaker can be encapsulated with an encapsulating material. The encapsulating material may be any material having a melting point greater than about 120° F. (48.89° C.), such as, from about 120° F. (48.89° C.) to about 350° F. (176.67° C.), from about 140° F. (60° C.) to about 300° F. (148.89° C.), from about 160° F. (71.11° C.) to about 250° F. (121.11° C.), from about 180° F. (82.22° C.) to about 220° F. (104.44° C.). The encapsulating material can comprise an acid-precursor including, but not limited to, polylactic acid, polyglycolic acid, and solid acids such as sulfamic, citric, or fumaric. To prevent the enzyme from immediately activating, and allowing for delayed breaking for a time, such as for about 1 or about 1.5 or about 2 or about 4 or about 6 or about 8 or about 12 or about 24 hours (i.e., delaying the breaking capability of the enzyme), the encapsulating material may be any suitable hydrophobic coating such as, for example, petroleum waxes and derivatives thereof such as paraffin wax, microcrystalline wax and petrolatum; montan wax and derivatives thereof; hydrocarbon waxes obtained by Fischer-Tropsch synthesis, and derivatives thereof; polyethylene wax and derivatives thereof; and naturally occurring waxes such as carnauba wax and candelilla wax, and derivatives thereof. The derivatives include oxides, block copolymers with vinyl monomers, and graft modified products. Additional encapsulating materials include, for example, acrylic polymers, such as ethylene acrylic acid copolymers (EAA); ethylene methyl acrylate copolymers (EMA); ethylene methacrylic acid polymers (EMMA); polyvinylidene chloride (PVdC), poly(vinyl)alcohol (PVOH), polyethylenes, ethyl cellulose, polyterpenes, polycarbonates and ethylene vinyl alcohol (EVOH). Selected clays can be used to further limit water intrusion through the polymeric coating. Other materials include polymethylene urea or phenol-aldehyde polymers.

Additional methods of removing the encapsulating material from the enzyme breaker include rupturing the material due to mechanical or shear stress, osmotic rupture, or dissolution.

The breaking effect of the enzyme breaker can be accomplished either in the presence or absence of a breaker activator (also referred to as a “breaking aid”). If employed, the breaker activator can be entirely different than the enzyme breaker discussed above. A breaker activator may be present to further encourage the redox cycle that activates the enzyme breaker. In some embodiments, the breaker activator may comprise an amine, such as oligoamine activators, for example, tetraethylenepentaamine (TEPA) and pentaethylenehexaamine (PEHA); or chelated metals. Further breaker aids may include ureas, ammonium chloride and the like, and those disclosed in, for example, U.S. Pat. Nos. 4,969,526, and 4,250,044, the disclosures of which are incorporated herein by reference in their entireties.

The amount of breaker activator that may be included in the viscosified or unviscosified treatment fluid (or aqueous or organic based fluid) is an amount that will sufficiently activate the breaking effect of the enzyme breaker, which is dependent upon a number of factors including the injection time desired, the polymeric material and its concentration, and the formation temperature. In embodiments, the breaker activator will be present in the viscosified or unviscosified treatment fluid (or aqueous or organic based fluid) in an amount in the range of from about 0.01% to about 1.0% by weight, such as from about 0.05% to about 0.5% by weight, of the viscosified or unviscosified treatment fluid (or aqueous or organic based fluid). In specific embodiments, no breaker activator may be present to sufficiently activate the breaking effect of the enzyme breaker.

The well treatment can also include a deactivator which can be any oxygen-containing arene capable of inhibiting the enzyme from breaking a crosslinked material. In particular, the deactivator may have one or more structural units, such as a phenol, naphthol, dimethoxybenzene, trimethoxybenzene, or a structure represented by Formula (1):

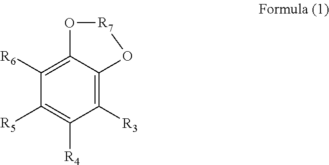

In Formula (1), R7 represents an alkyl group having about 1 to about 5 atoms optionally including one or more heteroatoms; and R3, R4, R5, and R6 each independently represents a hydrogen atom, a hydroxyl group, an alkyl group, an alkene group, an ester, a carboxylic acid, an alcohol, an aldehyde, a ketone, an aryl, an aryloxy, cycloalkyl, a carbonyl, or an amino group.

In some embodiments, the deactivator may be a phenolic compound or include a phenol subunit. For example, the phenolic compound may have a structure represented by Formula (2):

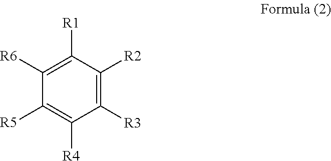

In Formula (2), R1 is OH; each of R2, R3, R4, R5, and R6 may independently be a hydrogen, hydroxyl group, alkyl group, alkene group, esters, carboxylic acid, alcohol, or aldehyde.

When one or more of R2, R3, R4, R5, and R6 is an alkyl group or an alkene group, the group may contain about 1 to about 18 carbon atoms, such as about 2 to about 15 or about 5 to about 12 carbon atoms.

The deactivators having a phenol structure or a phenol subunit may include, for example, methoxyphenol, ethoxyphenol, propoxyphenol, butoxyphenol, dimethoxyphenol, trimethoxyphenol, dihydroxy-methoxybenzene, dihydroxy-dimethoxybenzene, trihydroxyphenol, methoxy-methylphenol, allyl methoxyphenol, allyl dimethoxyphenol, rutin hydrate, epigallocatechin, epicatechin, 5-(3′4′5′-trihydroxyphenyl)-γ-valerolactone, gallic acid, tannic acid, vanillic acid, and salicylic acid. Examples of chemicals that have a sub-unit of the general formula 1 are tannic acid, polyphenon 60, ligninsulfonate, hesperidin, rutin hydrate, epigallocatechin gallate, 1-amino-2-naphthol, 2-amino-1-naphthol, 3-amino-2-naphthol, 4-amino-1-naphthol, 8-amino-1-naphthol, and 5-amino-1-naphthol.

In other embodiments, the deactivator may have a structure or include a structural subunit represented by Formula (3):

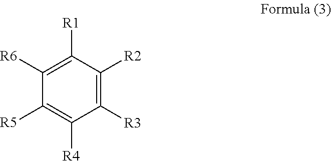

In Formula (3), R1 is OCH₃; each of R2, R3, R4, R5, and R6 may independently be a hydrogen, alkyl group, alkene group, ester, carboxylic acid, alcohol, aldehyde, ketone, or amino group.

Deactivators including a structure represented by Formula (3) may include, for example, 1,2-dimethoxybenzene, 1,3-dimethoxybenzene, 1,2,3-trimethoxybenzene, 1,2,4-trimethoxybenzene, 1,2,5-trimethoxybenzene, 1,2,6-trimethoxybenzene, and 1,3,5-trimethoxybenzene.

For example, the deactivator may be methoxyphenol, ethoxy phenol, propoxyphenol, butoxyphenol, dimethoxyphenol, trimethyoxyphenol, dihydroxy-methoxybenzene, dihydroxy-dimethoxybenzene, trihydroxyphenol, methoxy-methylphenol, allyl methoxyphenol, allyl dimethoxyphenol, rutin hydrate, epicatechin, 5-(3,4,5-trihydroxyphenyl)-γ-valerolactone, gallic acid, tannic acid, vanillic acid, salicyclic acid, guaiacol, polyphenon 60, liginsulfonate, hesperidin, epigallocatechin gallate, 1-amino-2-naphthol, 2-amino-1-naphthol, 3-amino-2-naphthol, 4-amino-1-naphthol, 8-amino-1-naphthol, 5-amino-1-naphthol, 1,2-dimethoxybenzene, 1,3-dimethoxybenzene, 1,2,3-trimethoxybenzene, 1,2,4-trimethoxybenzene, 1,2,5-trimethoxybenzene, 1,2,6-trimethoxybenzene, and 1,3,5-trimethoxybenzene, 1,3-benzodioxole, benzo-1,4-dioxane, 2,3-dihydro-1,4-benzodioxin-5-ol, 5-methoxy-1,3-benzodioxole, 5,6-dihydroxy-1,3-benzodioxole, sesamol, 5-methyl-1,3-benzodioxole, sesamin, piperonyl alcohol, piperonal, and 3,4-methylenedioxy aniline, 1,8-dihydroxynaphthalene, 1,5-dihydroxynaphthalene, 2,3-dihydroxynaphthalene, 2,7-dihydroxynaphthalene, 1,7-dihydroxynaphthalene, and 2,6-dihydroxynaphthalene.

The deactivator may be present in the treatment fluid in an effective amount for controlling the breaking of the crosslinked component by the enzyme and adjusting the viscosity of the treatment fluid. For example, the deactivator may be present in the treatment fluid in an amount in a range of from about 0.005 g/L to about 15 g/L, or about 0.1 g/L to about 10 g/L or about 0.1 g/L to about 1.5 g/L.

Suitable solvents for use with the unviscosified fluid, viscosified fluid, and/or enzyme breaker employed in the methods of the present disclosure may be aqueous or organic-based. In embodiments, the enzyme and breaker additive may be introduced into the subterranean formation in a fluid (aqueous or organic) that is separate from the unviscosified fluid or viscosified fluid. In embodiments, the breaking agent may be introduced into the subterranean formation after being mixed into either an unviscosified fluid or a viscosified fluid. Aqueous solvents may include at least one of fresh water, sea water, brine, mixtures of water and water-soluble organic compounds and mixtures thereof. Organic solvents may include any organic solvent which is able to dissolve or suspend the various components of the crosslinkable fluid. Mutual solvents such as ethylene glycol monobutyl ether or diethylene glycol monobutyl ether are also included.

In embodiments, the solvent, such as an aqueous solvent, may represent up to about 99.9 weight percent of the unviscosified or viscosified fluid, such as in the range of from about 85 to about 99.9 weight percent of the viscosified fluid, or from about 98 to about 99.7 weight percent of the viscosified fluid. The solvent may be a combination of any of the materials described above.

Additional Materials

While the viscosified fluids or viscosified treatment fluids of the present disclosure are described herein as comprising the above-mentioned components, it should be understood that the fluids of the present disclosure may optionally comprise other chemically different materials. In embodiments, the unviscosified and/or viscosified fluids of the present disclosure may further comprise stabilizing agents, surfactants, diverting agents, or other additives. Additionally, the unviscosified and/or viscosified fluids may comprise a mixture of various crosslinking agents, and/or other additives, such as fibers or fillers, provided that the other components chosen for the mixture are compatible with the intended application. In embodiments, the unviscosified and/or viscosified fluids of the present disclosure may further comprise one or more components selected from the group consisting of a conventional gel breaker, a buffer, a proppant, a clay stabilizer, a gel stabilizer, a surfactant and a bactericide. Furthermore, the unviscosified and/or viscosified fluids may comprise buffers, pH control agents, and various other additives added to promote the stability or the functionality of the fluid. The unviscosified and/or viscosified fluids may be based on an aqueous or non-aqueous solution. The components of the unviscosified and/or viscosified fluids may be selected such that they may or may not react with the subterranean formation that is to be fractured.

In this regard, the unviscosified and/or viscosified fluids may include components independently selected from any solids, liquids, gases, and combinations thereof, such as slurries, gas-saturated or non-gas-saturated liquids, mixtures of two or more miscible or immiscible liquids, and the like, as long as such additional components allow for the breakdown of the three dimensional structure upon substantial completion of the treatment. For example, the unviscosified and/or viscosified fluids may comprise organic chemicals, inorganic chemicals, and any combinations thereof. Organic chemicals may be monomeric, oligomeric, polymeric, crosslinked, and combinations, while polymers may be thermoplastic, thermosetting, moisture setting, elastomeric, and the like. Inorganic chemicals may be metals, alkaline and alkaline earth chemicals, minerals, and the like. Fibrous materials may also be included in the crosslinkable fluid or treatment fluid. Suitable fibrous materials may be woven or nonwoven, and may be comprised of organic fibers, inorganic fibers, mixtures thereof and combinations thereof.

Stabilizing agents can be added to slow the degradation of the crosslinked structure of the viscosified fluid after its formation downhole. Stabilizing agents may include buffering agents, such as agents capable of buffering at pH of about 8.0 or greater (such as water-soluble bicarbonate salts, carbonate salts, phosphate salts, or mixtures thereof, among others); polyols such as sorbitol or sodium gluconate, and chelating agents (such as ethylenediaminetetraacetic acid (EDTA), nitrilotriacetic acid (NTA), or diethylenetriaminepentaacetic acid (DTPA), hydroxyethylethylenediaminetriacetic acid (HEDTA), or hydroxyethyliminodiacetic acid (HEIDA), among others), which may or may not be the same as used for the coordinated ligand system of the chelated metal. Buffering agents may be added to the crosslinkable fluid or treatment fluid in an amount from about 0.05 wt % to about 10 wt %, and from about 0.1 wt % to about 2 wt %, based upon the total weight of the unviscosified and/or viscosified fluids. Chelating agents may also be added to the unviscosified and/or viscosified fluids.

The aqueous base fluids of the present application may generally comprise fresh water, salt water, sea water, a brine (e.g., a saturated salt water or formation brine), or a combination thereof. Other water sources may be used, including those comprising monovalent, divalent, or trivalent cations (e.g., magnesium, calcium, zinc, or iron) and, where used, may be of any weight.

Chelation is the formation or presence of two or more separate bindings between a multiple-bonded ligand and a single central atom. These ligands may be organic compounds, and are called chelating agents, chelants, or chelators. A chelating agent forms complex molecules with certain metal ions, inactivating the ions so that they cannot normally react with other elements or ions to produce precipitates or scale. Example of chelating agents include nitrilotriacetic acid (NTA); citric acid; ascorbic acid; hydroxyethylethylenediaminetriacetic acid (HEDTA) and its salts, including sodium, potassium, and ammonium salts; ethylenediaminetetraacetic acid (EDTA) and its salts, including sodium, potassium, and ammonium salts; diethylenetriaminepentaacetic acid (DTPA) and its salts, including sodium, potassium, and ammonium salts; phosphinopolyacrylate; thioglycolates; and a combination thereof. Other chelating agent are: aminopolycarboxylic acids and phosphonic acids and sodium, potassium and ammonium salts thereof; HEIDA (hydroxyethyliminodiacetic acid); other aminopolycarboxylic acid members, including EDTA and NTA (nitrilotriacetic acid), but also: DTPA (diethyl enetriamine-pentaacetic acid), and CDTA (cyclohexylenediamintetraacetic acid) are also suitable; phosphonic acids and their salts, including ATMP (aminotri-(methylenephosphonic acid)), HEDP (1-hydroxyethylidene-1,1-phosphonic acid), HDTMPA (hexamethylenediaminetetra-(methylenephosphonic acid)), DTPMPA (diethylenediaminepenta-(methylenephosphonic acid)), and 2-phosphonobutane-1,2,4-tricarboxylic acid.

Aqueous fluid embodiments may also comprise an organoamino compound. Examples of suitable organoamino compounds may include tetraethylenepentamine (TEPA), triethylenetetramine, pentaethylenehexamine, triethanolamine, and the like, or any mixtures thereof. When organoamino compounds are used in fluids described herein, they are incorporated at an amount from about 0.01 wt % to about 2.0 wt % based on total liquid phase weight. The organoamino compound may be incorporated in an amount from about 0.05 wt % to about 1.0 wt % based on total weight of the fluid.

Thermal stabilizers may also be included in the viscosified or unviscosified fluids. Examples of thermal stabilizers include, for example, methanol, alkali metal thiosulfate, such as sodium thiosulfate, ammonium thiosulfate and ascorbic acid or its sodium salt. The concentration of thermal stabilizer in the fluid may be from about 0.1 to about 5 weight %, from about 0.2 to about 2 weight %, from about 0.2 to about 1 weight %, from about 0.5 to about 1 weight % of the thermal stabilizers based on the total weight of the well treatment fluid.

One or more clay stabilizers may also be included in the viscosified or unviscosified fluids. Suitable examples include hydrochloric acid and chloride salts, such as, choline chloride, tetramethylammonium chloride (TMAC) or potassium chloride. Aqueous solutions comprising clay stabilizers may comprise, for example, 0.05 to 0.5 weight % of the stabilizer, based on the combined weight of the aqueous liquid and the organic polymer (i.e., the base gel). Surfactants can be added to promote dispersion or emulsification of components of the unviscosified and/or viscosified fluids, or to provide foaming of the crosslinked component upon its formation downhole. Suitable surfactants include alkyl polyethylene oxide sulfates, alkyl alkylolamine sulfates, modified ether alcohol sulfate sodium salts, or sodium lauryl sulfate, among others. Any surfactant which aids the dispersion and/or stabilization of a gas component in the fluid to form an energized fluid can be used. Viscoelastic surfactants, such as those described in U.S. Pat. Nos. 6,703,352; 6,239,183; 6,506,710; 7,303,018 and 6,482,866, the disclosures of which are incorporated herein by reference in their entireties, are also suitable for use in fluids in some embodiments. Examples of suitable surfactants also include, but are not limited to, amphoteric surfactants or zwitterionic surfactants. Alkyl betaines, alkyl amido betaines, alkyl imidazolines, alkyl amine oxides and alkyl quaternary ammonium carboxylates are some examples of zwitterionic surfactants. An example of a useful surfactant is the amphoteric alkyl amine contained in the surfactant solution AQUAT 944® (available from Baker Petrolite of Sugar Land, Tex.). A surfactant may be added to the crosslinkable fluid in an amount in the range of about 0.01 wt % to about 10 wt %, such as about 0.1 wt % to about 2 wt %.

Charge screening surfactants may be employed. In some embodiments, the anionic surfactants such as alkyl carboxylates, alkyl ether carboxylates, alkyl sulfates, alkyl ether sulfates, alkyl sulfonates, α-olefin sulfonates, alkyl ether sulfates, alkyl phosphates and alkyl ether phosphates may be used. Anionic surfactants have a negatively charged moiety and a hydrophobic or aliphatic tail, and can be used to charge screen cationic polymers. Examples of suitable ionic surfactants also include, but are not limited to, cationic surfactants such as alkyl amines, alkyl diamines, alkyl ether amines, alkyl quaternary ammonium, dialkyl quaternary ammonium and ester quaternary ammonium compounds. Cationic surfactants have a positively charged moiety and a hydrophobic or aliphatic tail, and can be used to charge screen anionic polymers such as CMHPG.

In other embodiments, the surfactant is a blend of two or more of the surfactants described above, or a blend of any of the surfactant or surfactants described above with one or more nonionic surfactants. Examples of suitable nonionic surfactants include, but are not limited to, alkyl alcohol ethoxylates, alkyl phenol ethoxylates, alkyl acid ethoxylates, alkyl amine ethoxylates, sorbitan alkanoates and ethoxylated sorbitan alkanoates. Any effective amount of surfactant or blend of surfactants may be used in aqueous energized fluids.

Friction reducers may also be incorporated in any fluid embodiment. Any suitable friction reducer polymer, such as polyacrylamide and copolymers, partially hydrolyzed polyacrylamide, poly(2-acrylamido-2-methyl-propane sulfonic acid) (polyAMPS), and polyethylene oxide may be used. Commercial drag reducing chemicals such as those sold by Conoco Inc. under the trademark “CDR” as described in U.S. Pat. No. 3,692,676 or drag reducers such as those sold by Chemlink designated under the trademarks FLO1003, FLO1004, FLO1005 and FLO1008 have also been found to be effective. These polymeric species added as friction reducers or viscosity index improvers may also act as excellent fluid loss additives reducing the use of conventional fluid loss additives. Latex resins or polymer emulsions may be incorporated as fluid loss additives. Shear recovery agents may also be used in embodiments.

Diverting agents may be added to improve penetration of the unviscosified and/or viscosified fluids into lower-permeability areas when treating a zone with heterogeneous permeability. The use of diverting agents in formation treatment applications is known, such as given in Reservoir Stimulation, 3^{rd} edition, M. Economides and K. Nolte, eds., Section 19.3.

The viscosified fluid for treating a subterranean formation of the present disclosure may be a fluid that has a viscosity above about 50 centipoise at 100 s⁻¹, such as a viscosity above about 100 centipoise at 100 s⁻¹ at the treating temperature, which may range from about 79.4° C. (175° F.) to about 135° C. (275° F.), such as from about 79.4° C. (175° F.) to about 121° C. (250° F.), from about 93.3° C. (200° F.) to about 121° C. (250° F.), or from about 93.3° C. (200° F.) to about 107° C. (225° F.). In embodiments, the crosslinked structure formed that is acted upon by the breaking agent may be a gel that is substantially non-rigid after substantial crosslinking. In some embodiments, a crosslinked structure that is acted upon by the breaking agent is a non-rigid gel. Non-rigidity can be determined by any techniques known to those of ordinary skill in the art. The storage modulus G′ of substantially crosslinked fluid system of the present disclosure, as measured according to standard protocols given in U.S. Pat. No. 6,011,075, the disclosure of which is hereby incorporated by reference in its entirety, may be about 150 dynes/cm² to about 500,000 dynes/cm², such as from about 1000 dynes/cm² to about 200,000 dynes/cm², or from about 10,000 dynes/cm² to about 150,000 dynes/cm².

Embodiments may also include proppant particles that are substantially insoluble in the fluids of the formation. Proppant particles carried by the unviscosified and/or viscosified fluids remain in the fracture created, thus propping open the fracture when the fracturing pressure is released and the well is put into production. Suitable proppant materials include, but are not limited to, sand, walnut shells, sintered bauxite, glass beads, ceramic materials, naturally occurring materials, or similar materials. Mixtures of proppants can be used as well. If sand is used, it may be from about 12 to about 150 U.S. Standard Mesh in size. With synthetic proppants, mesh sizes about 8 or greater may be used. Naturally occurring materials may be underived and/or unprocessed naturally occurring materials, as well as materials based on naturally occurring materials that have been processed and/or derived. Suitable examples of naturally occurring particulate materials for use as proppants include: ground or crushed shells of nuts such as walnut, coconut, pecan, almond, ivory nut, brazil nut, etc.; ground or crushed seed shells (including fruit pits) of seeds of fruits such as plum, olive, peach, cherry, apricot, etc.; ground or crushed seed shells of other plants such as maize (e.g., corn cobs or corn kernels), etc.; processed wood materials such as those derived from woods such as oak, hickory, walnut, poplar, mahogany, etc. including such woods that have been processed by grinding, chipping, or other form of particulation, processing, etc.

The concentration of proppant in the unviscosified and/or viscosified can be any concentration known in the art. For example, the concentration of proppant in the fluid may be in the range of from about 0.03 to about 3 kilograms of proppant added per liter of liquid phase. Also, any of the proppant particles can further be coated with a resin to potentially improve the strength, clustering ability, and flow back properties of the proppant.

Embodiments may further use unviscosified and/or viscosified fluids containing other additives and chemicals that are known to be commonly used in oilfield applications by those skilled in the art. These include materials such as surfactants in addition to those mentioned hereinabove, breaker activators (breaker aids) in addition to those mentioned hereinabove, oxygen scavengers, alcohol stabilizers, scale inhibitors, corrosion inhibitors, fluid-loss additives, bactericides and biocides such as 2,2-dibromo-3-nitrilopropionamine or glutaraldehyde, and the like. Also, they may include a co-surfactant to optimize viscosity or to minimize the formation of stable emulsions that contain components of crude oil.

In embodiments, the well treatment fluid may be driven into a wellbore by a pumping system that pumps one or more treatment fluids into the wellbore. The pumping systems may include mixing or combining devices, wherein various components, such as fluids, solids, and/or gases may be mixed or combined prior to being pumped into the wellbore. The mixing or combining device may be controlled in a number of ways, including, but not limited to, using data obtained either downhole from the wellbore, surface data, or some combination thereof.

The foregoing is further illustrated by reference to the following examples, which are presented for purposes of illustration and are not intended to limit the scope of the present disclosure.

### EXAMPLES

Sample Preparation

A synthetic brine containing approximately 300,000 mg/L was prepared in the following manner:
a) For 1 liter of the synthetic brine, solutions 1 and 2 below were prepared:

Solution 1

| | |
|---|---|
| DI water | 430 |
| Potassium Chloride | 3.38 |
| Sodium Chloride | 51.05 |
| Calcium Chloride Dihydrate | 102.79 |
| Magnesium Chloride Hexahydrate | 31.09 |

Solution 2

| | |
|---|---|
| DI water | 430 |
| Sodium Chloride | 153.16 |
| Sodium Bicarbonate | 0.072 |
| Sodium Sulfate (monoclinic) | 0.174 |
| Sodium Bromide | 1.22 |

b) Solutions 1 and 2 were mixed together to form the synthetic brine:

| Molecule | Mg/L (soln.) |
|---|---|
| Na⁺ | 8370 |
| K⁺ | 177 |
| Ca²⁺ | 2803 |
| Mg²⁺ | 372 |
| Cl⁻ | 18590 |
| Br⁻ | 95 |
| HCO₃⁻ | 252 |
| SO₄²⁻ | 430 |
| Water | 990174 |

Portions of the synthetic brine were then diluted with fresh water containing minor amounts of sodium bicarbonate and sodium sulfate to form brines representing 20, 25, 40, 50, 60, 75, 80 and 100 wt % of the synthetic brine (representing salinities of approximately: 60,000, 75,000, 120,000, 150,000, 180,000, 225,000 and 300,000 mg/L).

The samples tested in the following examples were prepared using the following method. The mix water was loaded into a Waring blender jar, and stirring was started. About 30 pounds of guar per thousand gallons (ppt) of mix water was added to the jar and hydrated for 30 minutes. A 1 gallon per thousand gallons (gpt) quantity of choline chloride was then added. When added for the higher temperature tests shown in FIG. 19, 1.5 gpt of a 10 wt % solution of hexamethylenetetramine and 0.85 gpt of a 25 wt % solution of sodium thiosulfate were added to the jar. The pH was then adjusted to about 5.5 with dilute acetic acid. Various quantities of a 1 wt % diluted solution of enzyme were then added. Zirconium crosslinkers were then added in quantities of either 0.5 gpt or 0.7 gpt.

Concentrations of the liquid pyrolase enzyme (“LP”) and pyrolase HT (“PHT”) enzyme, obtained from BASF, were first diluted to 1 wt % with DI water and used diluted. Fresh diluted enzyme was prepared each day of testing from the concentrate that was maintained at 35° F. in a refrigerator to prevent degradation. Encapsulated pyrolase HT enzyme (“Encap PHT”) and the Fraczyme enzyme (“F”) obtained from Howard Industries were used as supplied by the vendor, and were stored at room temperature.

Viscosity Measurements

Experiments were performed at different concentrations of enzyme and several temperatures including 125, 150, 175, 200, 225, and 250° F.

Evaluation of the breaking was made using viscosity measured on Grace 5600 viscometers using a geometry R1B5 at 100 s⁻¹. Periodically the shear rate was lowered to 75, 50, and 25 s⁻¹ and then raised to 50, 75 and 100 s⁻¹ to allow a power law model to be used for predicting viscosity with varying shear rate. Typically, 50 mL of fluid is loaded into the cup which is then attached to the viscometer and pressurized with nitrogen to a value from 300 to 500 psi. The experimental run is started at 100 s⁻¹ as heating starts to the final temperature. A relatively stable fluid without breaker added (baseline) is one which maintains viscosity above 100 cP as measured at the temperature of use and at a shear rate of 100 s⁻¹ for two to three hours. Breaking is evident when the viscosity departs from the baseline and more rapidly loses viscosity. Break times indicate where the fluid falls below the 100 cP line. Cooled fluids removed from the viscometer can also be checked for viscosity to ensure the breaker was effective in reducing polymer molecular weight and preventing the gelation.

### Example 1

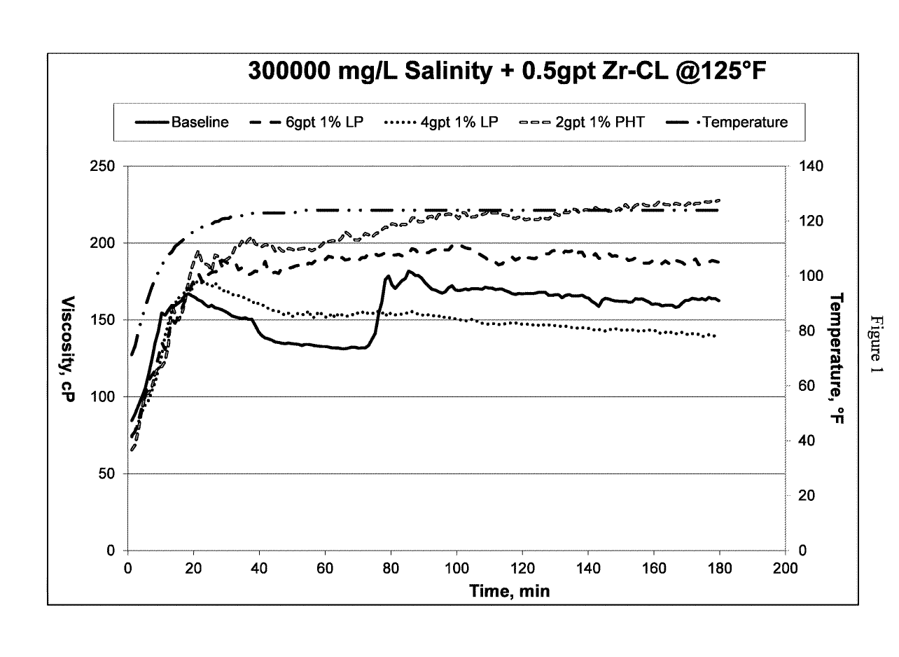

FIG. 1 shows viscosity results for fluids containing 300,000 mg/L salinity and 0.5 gpt of a zirconium crosslinker (“Zr-CL”) at 125° F., for different amounts of the enzymes LP and PHT.

### Example 2

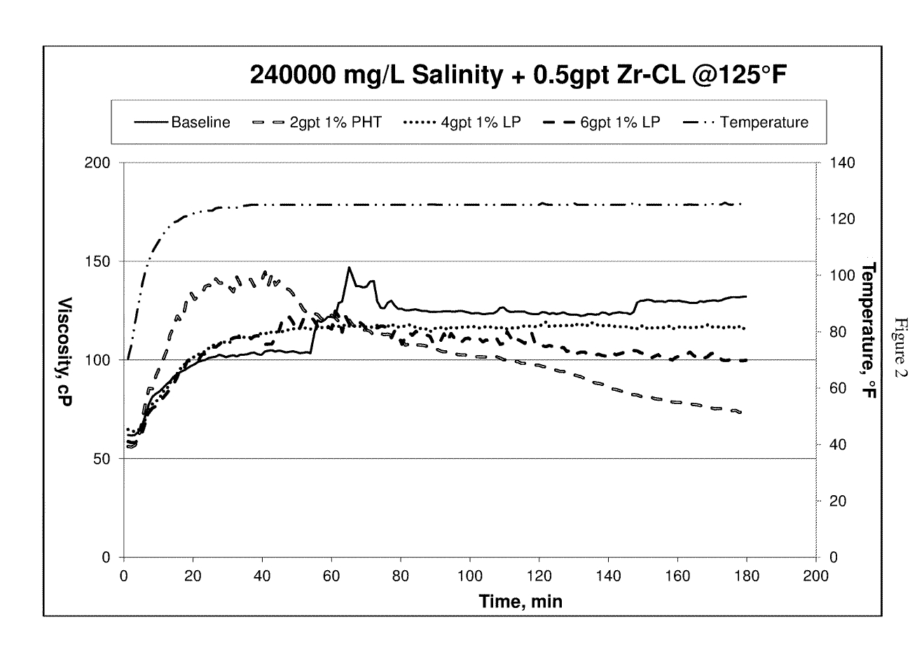

FIG. 2 shows viscosity results for fluids containing 240,000 mg/L salinity and 0.5 gpt of a Zr-CL at 125° F., for different amounts of the enzymes LP and PHT.

### Example 3

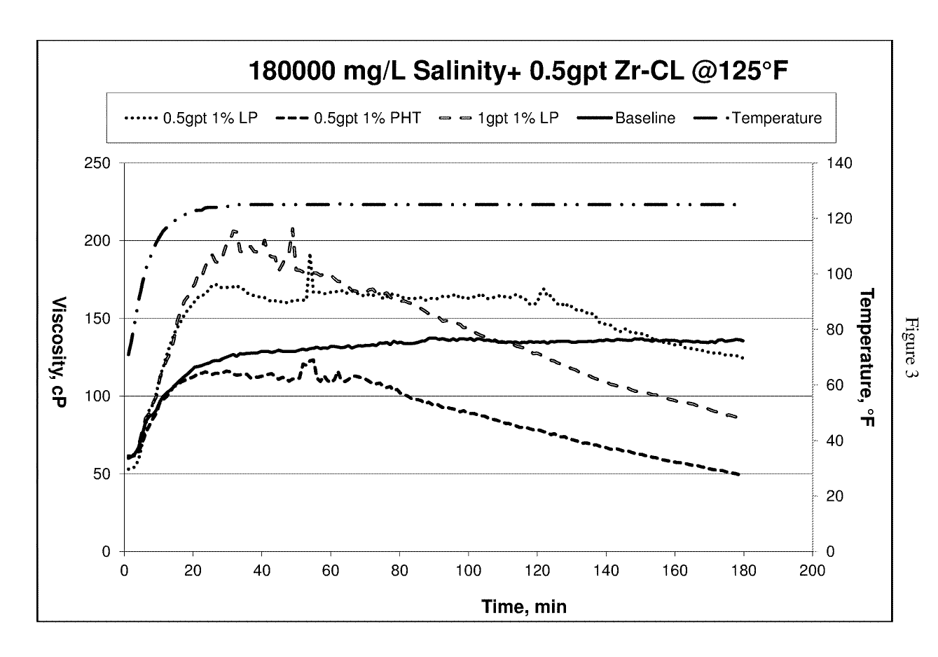

FIG. 3 shows viscosity results for fluids containing 180,000 mg/L salinity and 0.5 gpt of a Zr-CL at 125° F., for different amounts of the enzymes LP and PHT.

### Example 4

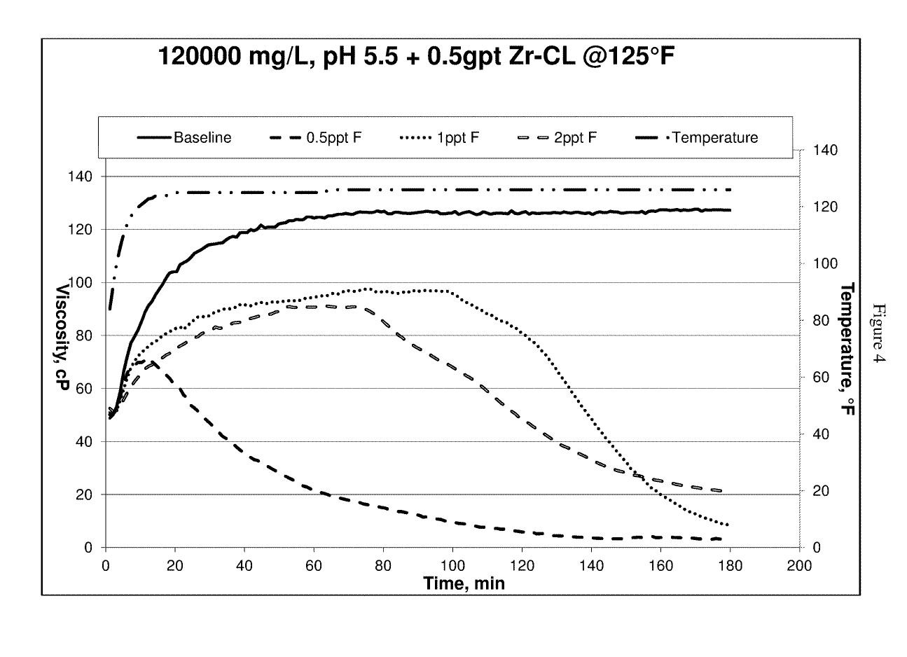

FIG. 4 shows viscosity results for fluids containing 120,000 mg/L salinity and 0.5 gpt of a Zr-CL at 125° F., for different amounts of enzyme F.

### Example 5

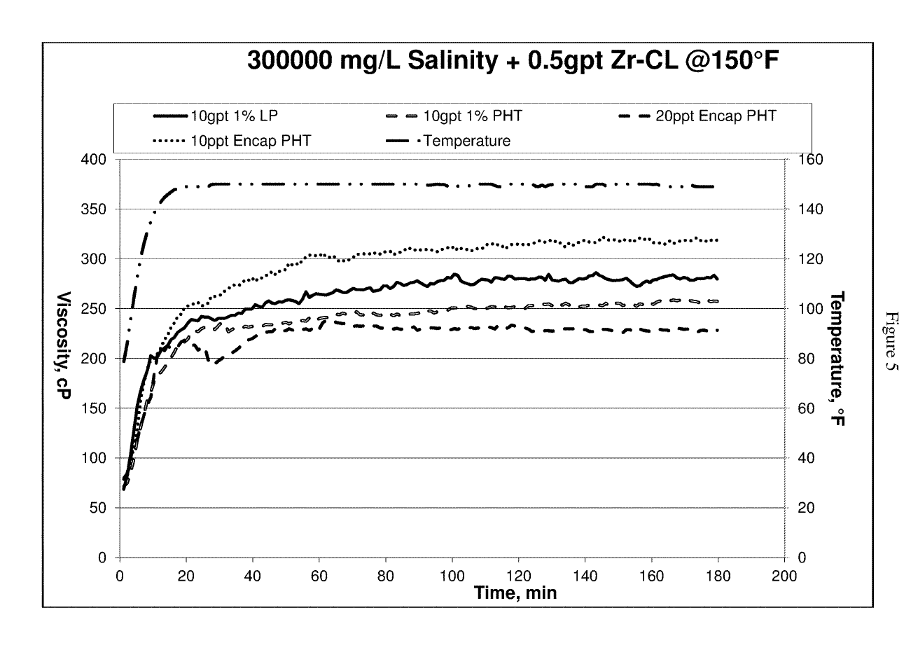

FIG. 5 shows viscosity results for fluids containing 300,000 mg/L salinity and 0.5 gpt of a Zr-CL at 150° F., for different amounts of LP and PHT enzymes.

### Example 6

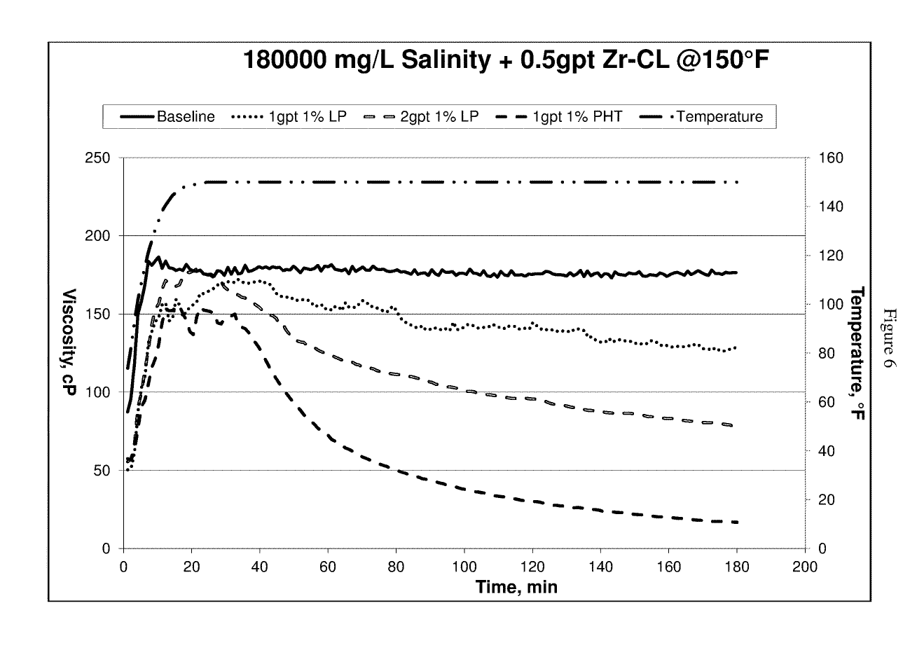

FIG. 6 shows viscosity results for fluids containing 180,000 mg/L salinity and 0.5 gpt of a Zr-CL at 150° F., for different amounts of LP and PHT enzymes.

### Example 7

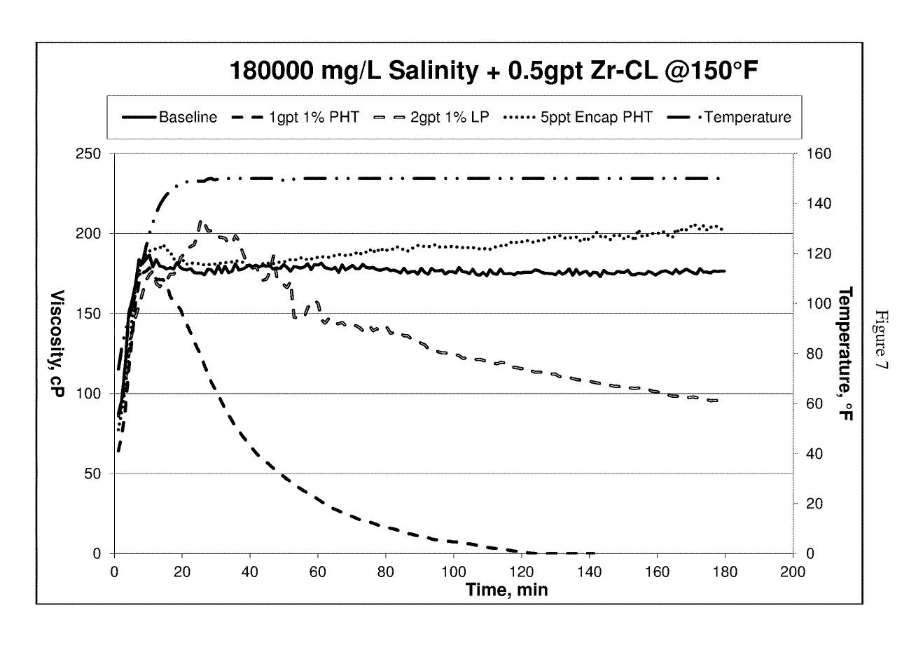

FIG. 7 shows viscosity results for fluids containing 180,000 mg/L salinity and 0.5 gpt of a Zr-CL at 150° F., for different amounts of LP, PHT and Encap PHT enzymes.

### Example 8

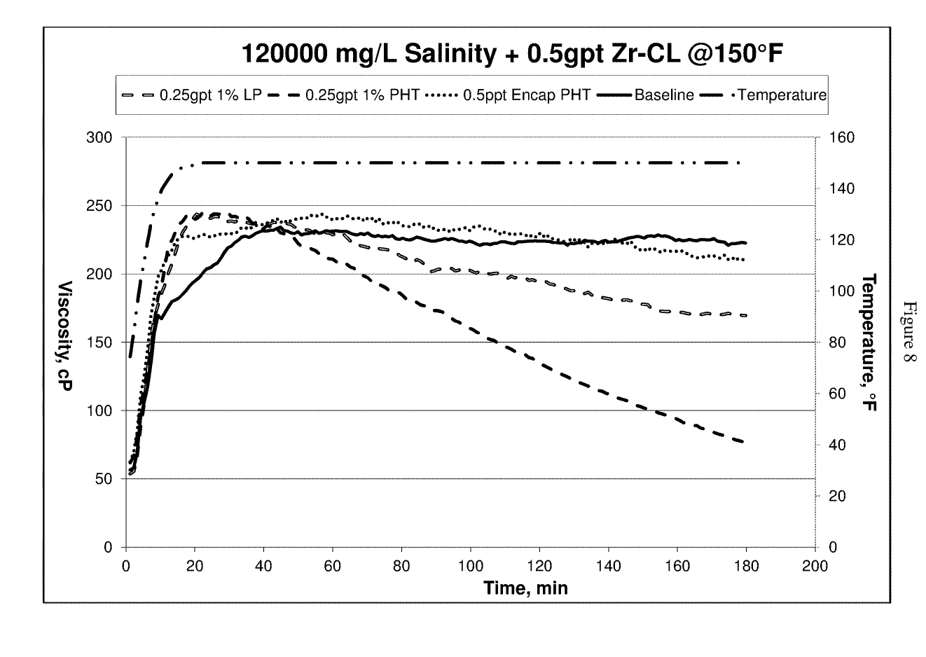

FIG. 8 shows viscosity results for fluids containing 120,000 mg/L salinity and 0.5 gpt of a Zr-CL at 150° F., for different amounts of LP, PHT and Encap PHT enzymes.

### Example 9

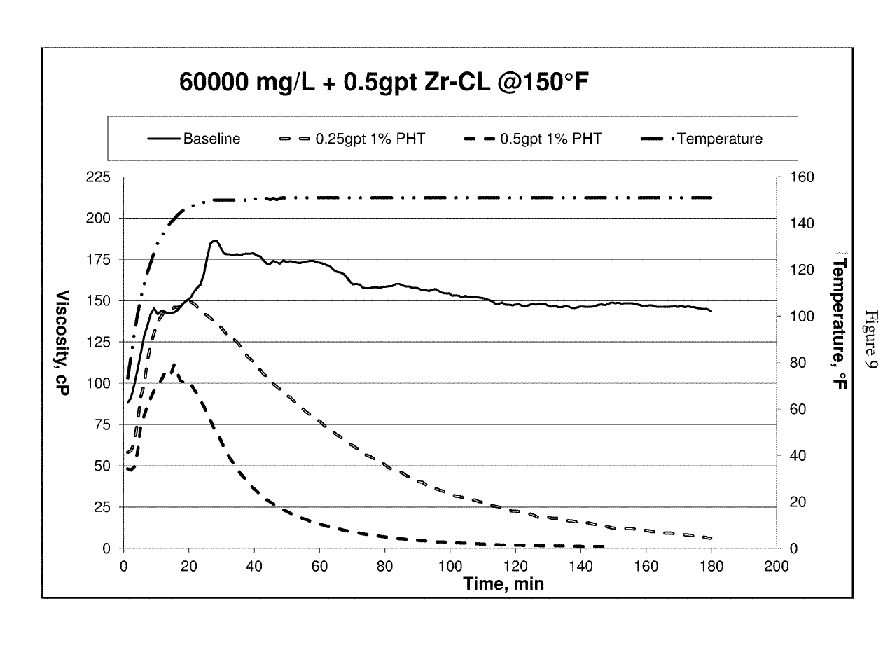

FIG. 9 shows viscosity results for fluids containing 60,000 mg/L salinity and 0.5 gpt of a Zr-CL at 150° F., for different amounts of the PHT enzyme.

### Example 10

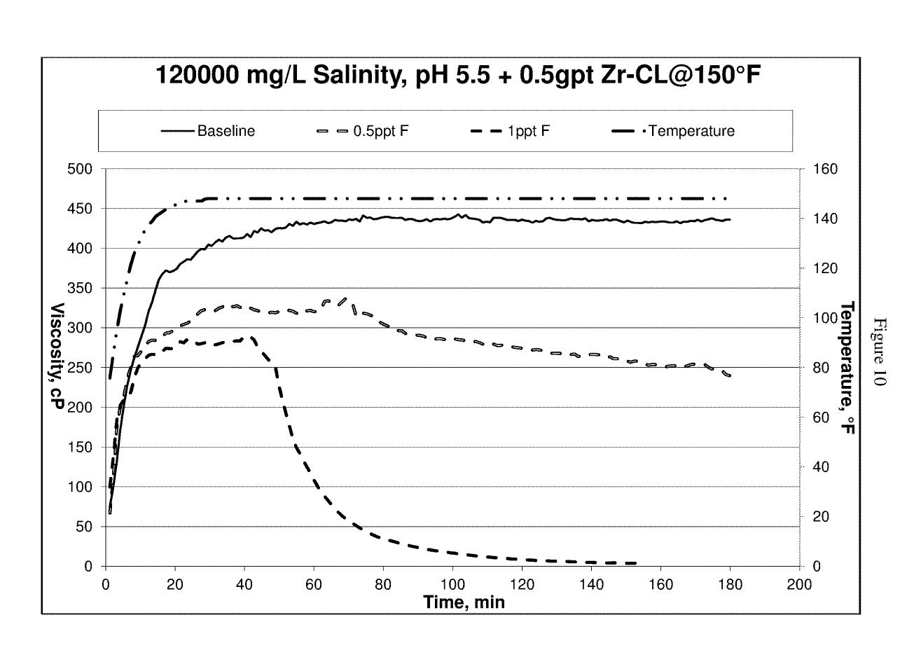

FIG. 10 shows viscosity results for fluids containing 120,000 mg/L salinity and 0.5 gpt of a Zr-CL at 150° F., for different amounts of the enzyme F.

### Example 11

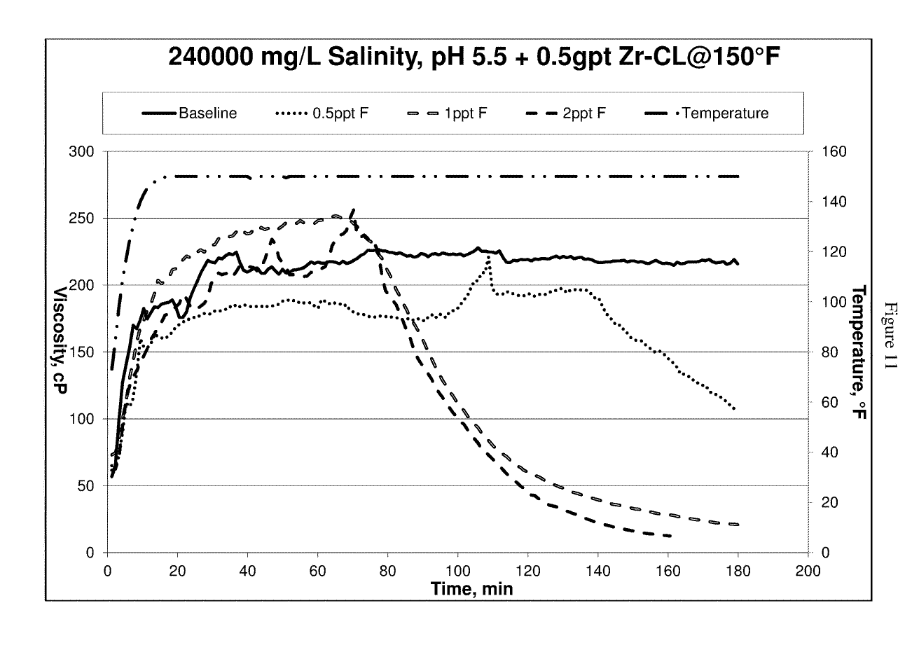

FIG. 11 shows viscosity results for fluids containing 240,000 mg/L salinity and 0.5 gpt of a Zr-CL at 150° F., for different amounts of the enzyme F.

### Example 12

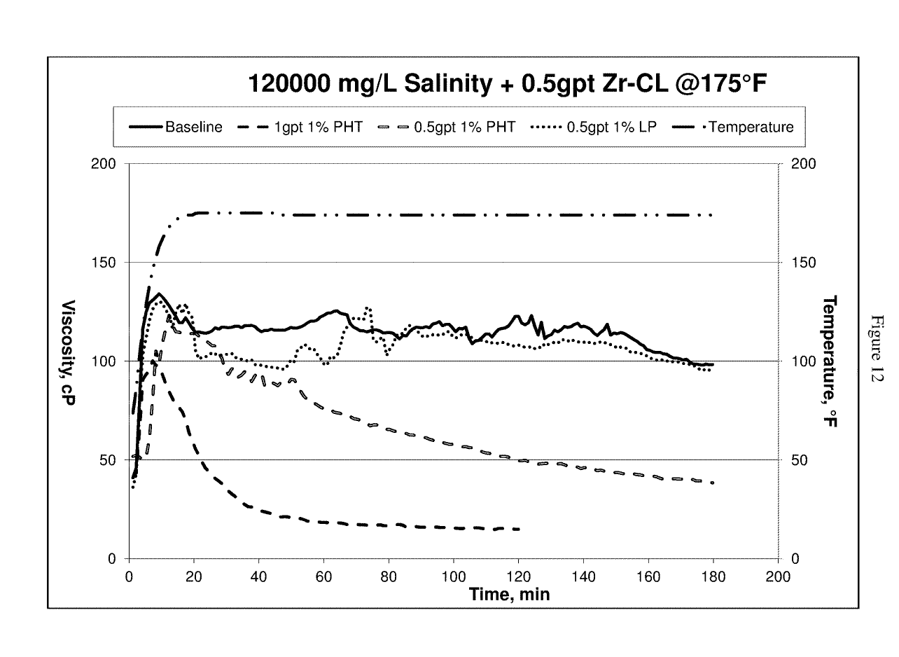

FIG. 12 shows viscosity results for fluids containing 120,000 mg/L salinity and 0.5 gpt of a Zr-CL at 175° F., for different amounts of LP and PHT enzymes.

### Example 13

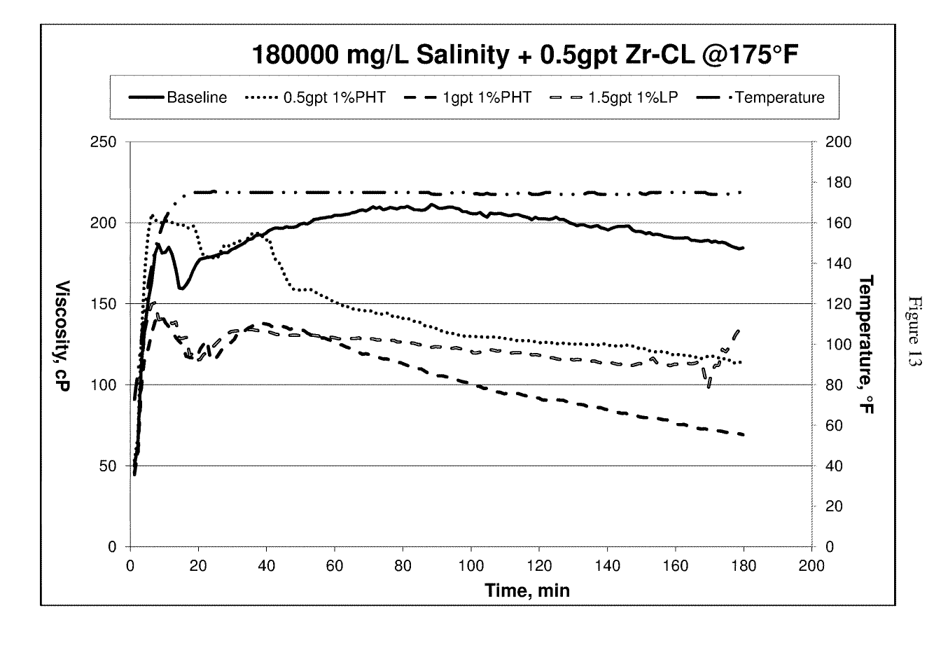

FIG. 13 shows viscosity results for fluids containing 180,000 mg/L salinity and 0.5 gpt of a Zr-CL at 175° F., for different amounts of LP and PHT enzymes.

### Example 14

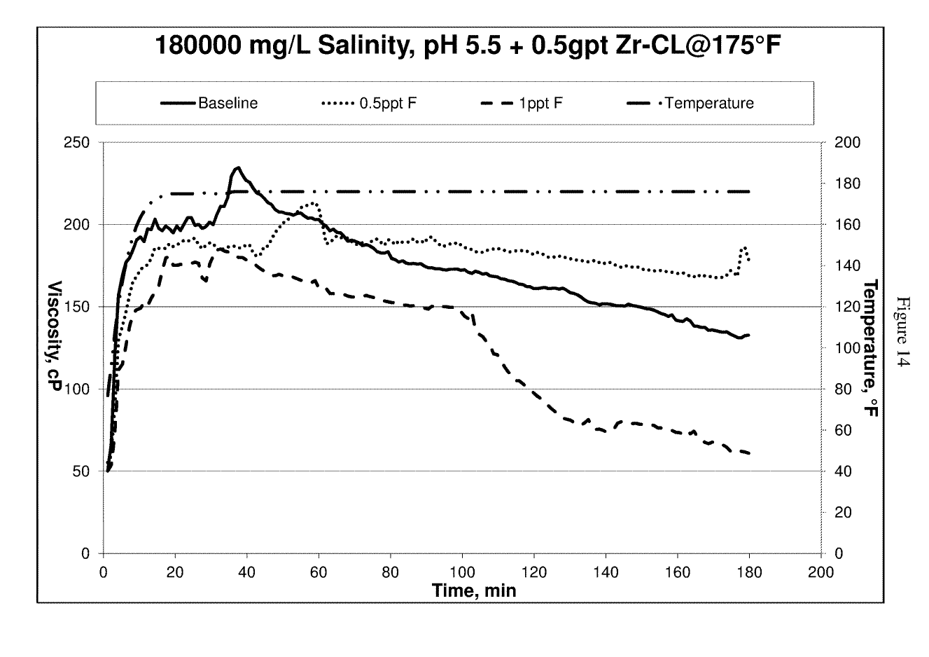

FIG. 14 shows viscosity results for fluids containing 180,000 mg/L salinity and 0.5 gpt of a Zr-CL at 175° F., for different amounts of the enzyme F.

### Example 15

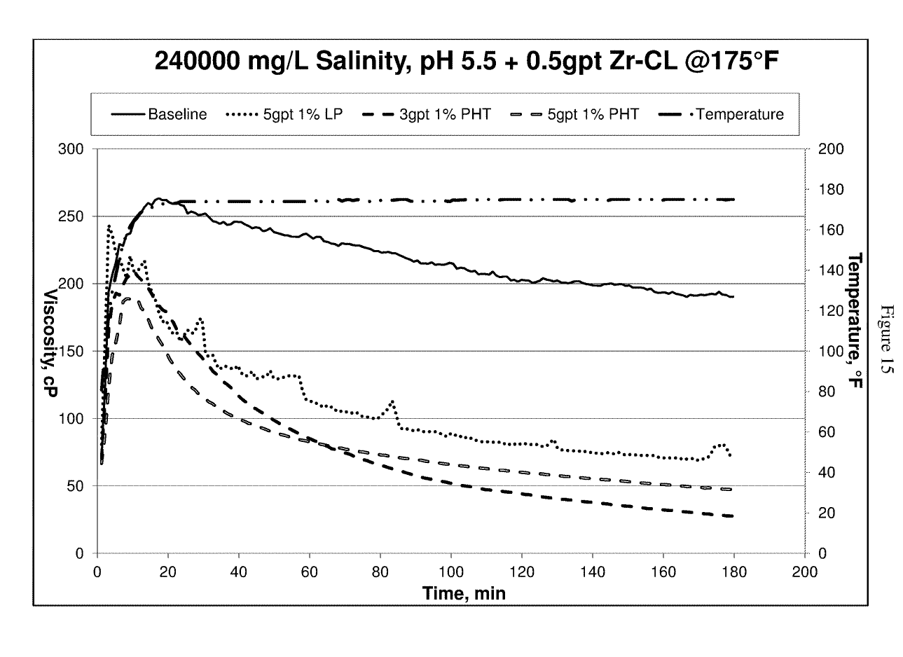

FIG. 15 shows viscosity results for fluids containing 240,000 mg/L salinity and 0.5 gpt of a Zr-CL at 175° F., for different amounts of LP and PHT enzymes.

### Example 16

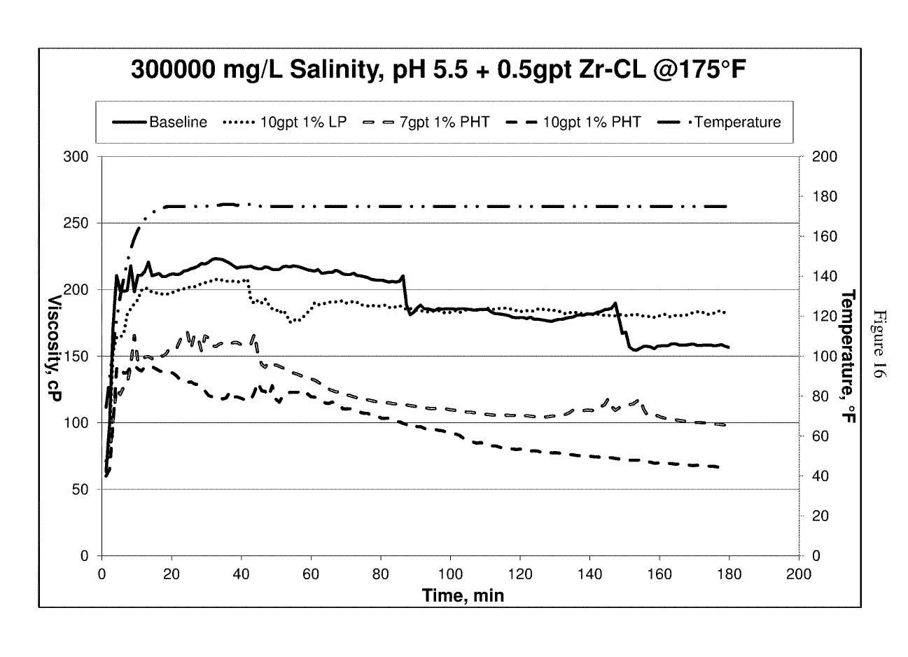

FIG. 16 shows viscosity results for fluids containing 300,000 mg/L salinity and 0.5 gpt of a Zr-CL at 175° F., for different amounts of LP and PHT enzymes.

### Example 17

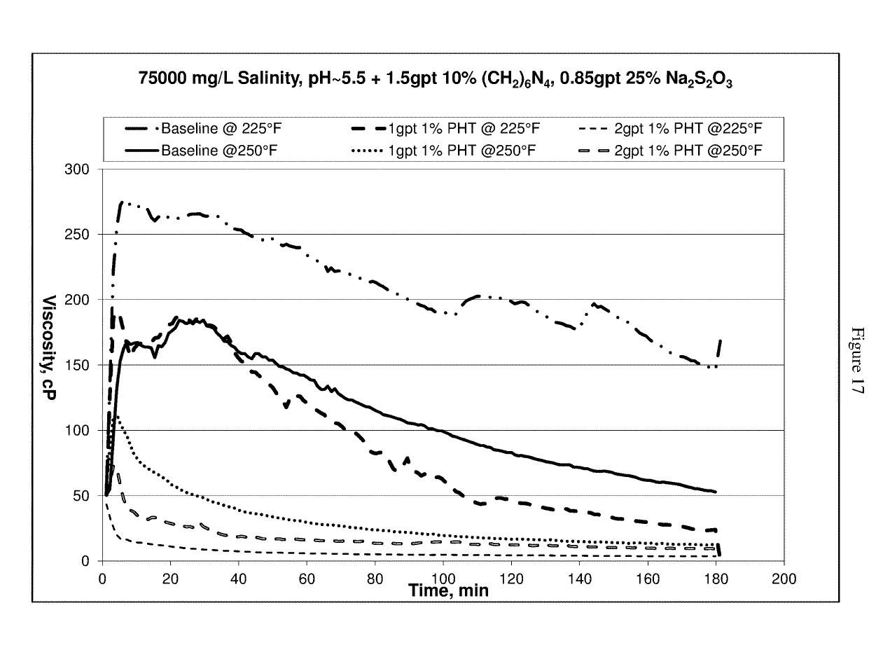

FIG. 17 shows viscosity results for fluids containing 75,000 mg/L salinity, 0.5 gpt of a Zr-CL, and with 1.5 gpt of a 10 wt % solution of hexamethylenetetramine (“(CH₂)₆N₄”) and 0.85 gpt of a 25 wt % solution of sodium thiosulfate (“Na₂S₂O₃”) at both 225° F. and 250° F., for different amounts of the PHT enzyme.

It was found that the enzymes were inactive at 100% PMW or 300,000 mg/L but showed some activity at 240,000 mg/L salinity. FIG. 1 shows results for 100% PMW brine at 125° F. and no enzyme activity is evident for the LP and PHT enzymes. FIG. 2 and FIG. 3 show breaking activity with the LP and PHT enzymes at 240,000 and 180,000 mg/L salinity, respectively, while FIG. 4 shows breaking activity with the encapsulated enzyme F at 120,000 mg/L salinity.

As shown in FIGS. 2 and 3, more enzyme is needed to elicit a breaking response for 240,000 mg/L salinity than at 180,000 mg/L salinity. Also, the PHT enzyme is more efficient than the LP enzyme. The enzyme F also shows breaking activity in FIG. 4. Because of the coating, the onset of breaking is more pronounced when the breaker is released than seen with liquid enzymes.

At 150° F., no breaker activity is seen with the PHT or the Encap PHT enzymes in a 300,000 mg/L salinity fluid (FIG. 5). When the salinity is reduced to 180,000 mg/L, breaking is readily observed for both the LP and PHT enzymes, but not for the Encap PHT (See FIGS. 6 and 7). This is probably a result of the capsule not releasing breaker at this temperature. At 120,000 mg/L salinity brine, breaking is evident even at 0.25 gpt of enzyme (FIG. 8).

FIG. 9 shows at 60,000 mg/L salinity brine breaking results at very low levels of enzyme. FIG. 10 shows breaking activity with the enzyme F in 120,000 mg/L salinity brine, while FIG. 11 shows breaking activity for enzyme F in 240,000 mg/L salinity brine.

At 175° F., enzymes LP and PHT show breaking activity in 120,000 mg/L salinity brine at low levels of enzyme concentration (FIG. 12). Lower levels are needed as temperature increases due to increased enzyme activity with temperature. As seen in FIG. 13, increased salinity means higher levels of enzyme are needed. As shown in FIG. 14, encapsulated enzyme F reduces the viscosity in 180,000 mg/L salinity brine. The LP and PHT enzymes show breaking activity in 240,000 mg/L salinity brine (FIG. 15). FIG. 16 shows that the LP and PHT enzymes can work in 300,000 mg/L salinity brine if the temperature is higher (wherein the enzyme activity is enhanced) and if large concentrations are used (from 7-10 gpt). However, the early viscosity of the fluid is also compromised.

At 225° F., the PHT enzyme is still effective as seen in FIG. 17 for 75,000 mg/L salinity brine. However, the efficiency is lower since the activity of the enzyme breaker drops off after about 175° F. Early breaking is also evident in the data of FIG. 17. The curves in FIG. 17 for the 250° F. runs also show breaker effectiveness for the PHT enzyme.

Although the preceding description has been described herein with reference to particular means, materials and embodiments, it is not intended to be limited to the particulars disclosed herein; rather, it extends to all functionally equivalent structures, methods and uses, such as are within the scope of the appended claims. Furthermore, although only a few example embodiments have been described in detail above, those skilled in the art will readily appreciate that many modifications are possible in the example embodiments without materially departing from this disclosure. Accordingly, all such modifications are intended to be included within the scope of this disclosure as defined in the following claims.

What is claimed is:

1. A method of treating a subterranean formation, the method comprising:
a) providing a well treatment fluid comprising water, a crosslinkable component, a crosslinker and an enzyme breaker comprising a cellulase enzyme; wherein the treatment fluid attains a temperature T1 from about 125° F. to about 275° F., has an initial pH from about 4.5 to about 8, a total dissolved solids content of at least about 75,000 mg/L up to about 250,000 mg/L, and an initial viscosity greater than about 150 cP measured at the temperature T1 and at a shear rate of 100 s⁻¹;
b) placing the well treatment fluid into the subterranean formation; and
c) wherein the viscosity of the well treatment fluid after about 2 hours from placement in the subterranean formation is below about 100 cP measured at the temperature of use and at a shear rate of 100 s⁻¹.

2. The method of claim 1 wherein the cellulase enzyme is selected from the group consisting of pyrolase enzyme, encapsulated pyrolase HT enzyme, pyrolase HT enzyme, fraczyme enzyme, and combinations thereof.

3. The method of claim 2 wherein the cellulase enzyme is pyrolase HT enzyme.

4. The method of claim 3 wherein the crosslinkable component is selected from the group consisting of guar, CMHPG, and combinations thereof.

5. The method of claim 4 wherein the crosslinkable component is guar.

6. The method of claim 4 wherein the crosslinker comprises a metal component selected from the group consisting of zirconium, titanium and aluminum.

7. The method of claim 4 wherein the enzyme breaker is encapsulated with an encapsulating material.

8. The method of claim 7 wherein the encapsulating material comprises an acid-precursor.

9. The method of claim 6 wherein the metal component of the crosslinker is present in the well treatment fluid in an amount of from about 10 to about 200 ppm, based on the total weight of the well treatment fluid.

10. The method of claim 9 wherein the cellulase enzyme is present in the well treatment fluid in an amount of from about 0.0001 to about 0.03 wt %, based on the total weight of the well treatment fluid.

11. The method of claim 10 wherein the crosslinkable component is present in the well treatment fluid in an amount of from about 0.1 to about 0.72 wt %, based on the total weight of the well treatment fluid.

12. A well treatment fluid comprising:
a) water;
b) a crosslinkable component;
c) a crosslinker; and
d) an enzyme breaker comprising a cellulase enzyme;
wherein the well treatment fluid has a total dissolved solids content of at least about 75,000 mg/L up to about 250,000 mg/L, a pH from about 4.5 to about 8, and a viscosity greater than about 150 cP measured at the temperature of use and at a shear rate of 100 s⁻¹.

13. The well treatment fluid of claim 12 wherein the cellulase enzyme is selected from the group consisting of pyrolase enzyme, pyrolase HT enzyme, encapsulated pyrolase HT enzyme, fraczyme enzyme, and combinations thereof.

14. The well treatment fluid of claim 13 wherein the crosslinkable component is selected from the group consisting of guar, CMHPG, and combinations thereof.

15. The well treatment fluid of claim 14 wherein the crosslinker comprises a metal component selected from the group consisting of zirconium, titanium and aluminum.

16. The well treatment fluid of claim 15 wherein the cellulase enzyme is present in the well treatment fluid in an amount of from about 0.0001 to about 0.03 wt %, based on the total weight of the well treatment fluid; the crosslinkable component is present in the well treatment fluid in an amount of from about 0.1 to about 0.72 wt %, based on the total weight of the well treatment fluid; and the metal component of the crosslinker is present in the well treatment fluid in an amount of from about 10 to about 200 ppm, based on the total weight of the well treatment fluid.

17. A method of treating a subterranean formation, the method comprising:
a) providing a first fluid comprising water, a crosslinkable component, a crosslinker, and an enzyme breaker comprising a cellulase enzyme, wherein the first fluid has a total dissolved content A;
b) placing the first fluid into the subterranean formation comprising an aqueous formation fluid having a total dissolved content B which is higher than the total dissolved content A of the first fluid;
c) combining the first fluid with the aqueous formation fluid in the subterranean formation to form a well treatment fluid, wherein the well treatment fluid attains a temperature T1 from about 125° F. to about 275° F., has an initial pH from about 4.5 to about 8, a total dissolved solids content of at least about 75,000 mg/L up to about 250,000 mg/L, and an initial viscosity greater than about 150 cP measured at the temperature T1 and at a shear rate of 100 s⁻¹;
d) wherein the viscosity of the well treatment fluid after about 2 hours from forming in the subterranean formation is below about 100 cP measured at the temperature of use and at a shear rate of 100 s⁻¹.

18. The method of claim 17 wherein the cellulase enzyme is selected from the group consisting of pyrolase enzyme, pyrolase HT enzyme, encapsulated pyrolase HT enzyme, fraczyme enzyme, and combinations thereof.

19. The method of claim 18 wherein the crosslinker comprises a metal component selected from the group consisting of zirconium, titanium and aluminum.

20. The method of claim 19 wherein the enzyme breaker is encapsulated with an encapsulating material.
